(19) United States
(12) Patent Application Publication
(10) Pub. No.: US 2006/0047713 A1
(43) Pub. Date: Mar. 2, 2006

(54) System and method for database replication by interception of in memory transactional change records

(75) Inventors: David Gornshtein, Hod Hasharon (IL); Boris Tamarkin, Bothell, WA (US)

Correspondence Address: DARBY & DARBY P.C., P. O. BOX 5257, NEW YORK, NY, 10150-5257, US

(73) Assignee: WisdomForce Technologies, Inc., Bothell, WA (US)

(21) Appl. No.: 11/189,220

(22) Filed: Jul. 25, 2005

Related U.S. Application Data
(60) Provisional application No. 60/598,613, filed on Aug. 3, 2004.

(51) Int. Cl. G06F 17/30

(52) U.S. Cl. 707/202

(57) ABSTRACT

A system and method are directed towards providing a database replication technique using interception in memory of the transaction change data records. The invention employs Input/Output instrumentation to capture and split out the in memory transaction change journal records. Captured memory blocks are sent to a parser, which concatenates the records into a single record, and creates a redo/undo vector that can be converted to original DML/DDL statements. Source level transformations can be applied to the vectors, which are then sent to a post agent on the same or a different computing device. The post agents may perform destination level transformations, and generate DML/DDL statements to be executed by the corresponding destination RDBMS instance. Post agents may also perform conflict detection and resolution during DML/DDL statement executions. Transaction consistency is supported by performing commits/rollback on the destination after receiving the redo/undo vector representing a commit/rollback on the source.

### CROSS-REFERENCE TO RELATED APPLICATIONS

The present application claims priority from provisional application Ser. No. 60/598,613 entitled “System and Method for Database Replication by Interception of in Memory Transactional Change Records,” filed on Aug. 3, 2004 under 35 U.S.C. §119 (e), and which is further hereby incorporated by reference within.

### FIELD OF THE INVENTION

The present invention relates generally to computing database management systems, and more particularly, but not exclusively to a method and system for replicating of databases by intercepting in memory transactional change records.

### BACKGROUND OF THE INVENTION

A database may be characterized as a collection of information that is organized in such a way that a computer program may quickly selected desired pieces of the data. Traditional databases are organized using fields, records, and tables, where a field may be a single piece of data; a record may include a collection of fields; and a table may include a collection of records.

Databases may employ a variety of methods to organize and link fields, tables, and records together and to map or to distribute these items across Operating System (OS) files or raw devices. For example, one such method is a non-relational or hierarchical approach where records in one file may include embedded pointers to locations of records in another. Another method uses a Relational Data Base Management System (RDBMS) where relationships between tables may be created by comparing data. The RDBMS may further structure the data into tables. Such tables may then be employed for storing and retrieving data. Many RDBMS applications employ a Structured Query Language (SQL) interface to manage the stored data. The SQL interface may allow a user to formulate a variety of relational operations on the data interactively, in batch files, with an embedded host language, such as C, COBOL, Java, and so forth. For example, a Data Definition Language (DDL) operation may be performed on a database schema in the RDBMS to create a table, alter a table, drop a table, truncate a table, and the like. Furthermore, a Data Manipulation Language (DML) operation may be performed within the RDBMS to insert, update, and delete data, a table, or the like.

Replication is a process of maintaining a defined set of data in more than one location. It may involve copying designated changes from one location (a source) to another (a target), and synchronizing the data in both locations. Replicated databases provide work fields that allow the creation and inspection of data without limiting access by others to the source or primary database. If specific aspects of the source database are desired, replicas of particular tables or even columns in tables can be provided to avoid absorbing excess resources. In addition, data transformation can be performed during the replication process.

Businesses and enterprises have significant needs for data movement and replication in such areas as Enterprise Application Integration, disaster recovery/high availability and migrating data in zero downtime, to name just a few. Moreover, it may be desirable to replicate changes in real time between different databases in either a homogeneous or a heterogeneous environment. It may also be desirable to provide support to a maser-to-master replication configuration where the target databases can also be a source database.

Traditionally, there have been two ways to implement replication, using either a log-based or a trigger-based approach. Trigger-based approaches use database triggers on replicated tables to capture changed data. Database triggers may be applied to mark tables to capture the data involved in a replicated transaction. Moreover, triggers may be used to enable the recording of other information the replication needs to replicate the transaction, such as a transaction identifier (ID) that identifies each operation associated with a transaction.

However, in some database structures, a trigger may not operate within the context of a transaction that called the trigger. This may in turn complicate transaction rollbacks for changes to the database. Moreover, may be dependent on a source table structure. Where the table structure changes, then the trigger may cease to properly function.

Log-based replication, however, reads changes from source database log files called transaction journals and delivers the changes to a target database. An agent may be employed to monitor the transaction journals. When a change occurs, the agent captures the changes and sends them to the target database where the changes may be applied.

In order to make log-based replication work, primary databases are implemented in an archive mode where the transaction journals are written and overwritten in a circular fashion to minimize overwriting of information blocks that may not have been read by the capturing agent. However, due to the disk space, performance implications, disk space and administration constraints, there is a need in the industry for improved replication methods. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention showing three layers for instrumentation;

FIG. 2 shows a functional block diagram illustrating another embodiment of an environment for practicing the invention showing the three layers for instrumentation;

FIG. 3 illustrates a logical flow diagram generally showing one embodiment of a process for employing an instrumented layer;

FIG. 4 illustrates a Specification and Description Language (SDL) diagram generally showing one embodiment of a process for a TX change interceptor;

FIG. 5 illustrates a SDL diagram generally showing one embodiment of a process for the RepkaDB engine;

FIG. 6 illustrates a logical flow diagram generally showing one embodiment of a process for transaction loopback;

FIG. 7 illustrates a specification and description language (SDL) diagram generally showing one embodiment of a process for transaction loopback filtering; and

FIG. 8 shows one embodiment of a server device that may be included in a system implementing the invention, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards providing a replication technique using interception in memory of the transaction change data records. This may be accomplished by code instrumentation to perform in memory transactional change (or redo or transactional journal) record interceptions. Such instrumentation can be performed by one of three possible layers: as a database or instance level storage manager; by instrumentation of Operating System Input/Output (OS IO) functions; and by implementing a “device wrapper” on an underlying device driver level.

Improvements in log-based replication may include elimination of many input/output operations' overhead, savings in disk space, and simplification of administration. Moreover, the invention is directed towards satisfying an unmet need for log-based synchronous replication. Synchronous replication is directed towards avoiding conflicts and changes collisions. Improvements may also arise from the fact that the invention's in memory change block interceptor does not require the system to archive log files, so less disk space and less IO operations may be required. In addition, there is no necessity to backup and delete archived transactional journal files as is required in replication based on transaction journal file polling. Moreover, the present invention provides a Master-to-Master replication real-time ping pong avoidance mechanism.

The present invention is configured to catch change blocks in memory as opposed to reading them from a disk based transaction journal. By avoiding use of the disk based transaction journal (logs), the invention further avoids decreases in performance of the RDBMS due to archiving of the transaction journals.

Additionally, the invention allows for propagation of event changes optimized for no-logging events, where another log based replication may be unable to catch the changes. This may be achieved because the present invention works as I/O interceptor. Thus, where log changes are flushed to disk before the data is flushed, the present invention can intercept data blocks according to any metadata that may be flushed to a transactional journal.

The present invention employs the fact that most of the existing relational databases on the market today allow for concurrent transactional processing and usually include a single instance or database level transactional change writer process. Where the database may include several writer processes, such as in a cluster environment, there is typically some mechanism for ordering (or sorting) the change records in a deterministic time based approach. Change record sorting may be implemented by a database, to allow point-in-time recovery of database.

However, there are some RDBMS′ that operate on a high level of concurrency without transactional changes journals. Instead they may employ an over multi-versioning mechanism. In such situations, an alternative agent configuration may be implemented such as instrumentation at higher program layers.

Additionally, the present invention may catch bulk inserts performed during a no-logging mode. Databases may have a special optional optimization mechanism that is related to logging/no logging. For example, in some cases when the Database Administrator (DBA) wants to achieve high performance, then some operations may be performed without using a logging mechanism. In those cases, existing standard log-based replication may not capture the changes, and therefore, the changes may not be replicated. However, the present invention allows interception of the log records (transactional changes). For instance, metadata related to transaction journal records identifies allocated or freed blocks, and then intercepts the data itself rather than log records.

As briefly described above, the present invention may perform instrumentation at various layers of an RDBMS operating environment. Thus, one embodiment includes implementing or instrumentation of a database or instance level storage manager layer of database server software. The storage manager may include virtually the same external API as a replaced instance level storage layer and thus is able to identify effectively a transactional change writer process. Additionally, the storage manager may duplicate information processed by the change writer and send it to two streams. One of the streams (records) may be flushed to an underlying device (such as a disk/raid/DASD/storage, and the like) synchronously, while a second stream may be sent to a Replicating DataBase (RepkaDB) change (record) parser engine. There are at least two ways of sending the second stream to the RepkaDB engine. The first way is to provide the stream synchronously, such as for synchronous (real-time) replication. In one embodiment, a function call (write) may not return until receiving a response from the RepkaDB engine that a transaction is committed on the target database. The second way is to provide the stream asynchronously, such as may be employed for asynchronous or near real-time replication. In the second way, actions may not depend on a response from the RepkaDB engine.

An example of this embodiment can be implementation of an Oracle disk management API (ODM). A default Oracle supplied ODM may be replaced by the RepkaDB engine that effectively identifies the transactional change writer process (in the Oracle example it may include an oracle log writer) as a single process in each instance updating redo log files. At the same time the RepkaDB engine may intercept direct write or no logging operations to data files according to metadata change records, which are identified by intercepting log writer writes.

As described above, another embodiment includes instrumentation of Operating System Input/Output (OS IO) functions (IO Manager). That is, the invention employs implementation of a new or a wrap to an existing OS IO functions used by database server software. The instrumented IP manager employs substantially similar OS IO functions that enable it to effectively identify a transactional change writer process. Additionally, the instrumented IO Manager may duplicate substantially all the information processed by the writer in such way that when the database server requests an operation, information will be sent to the underlying OS function.

Duplicated information may be sent to a RepkaDB change (record) parser engine synchronously, as in the case of synchronous (real-time) replications, and asynchronously for near real-time replications.

An example of such implementation can include a Unix OS IO function implementation that replaces existing components with the instrumented IO Manager. The instrumented IO Manager may identify the transactional change writer process as a single process in an instance of updating redo log files. Then, the instrumented IO Manager may intercept write operations to redo log files.

Yet another embodiment of the invention employs a creation of a device driver wrapper. This embodiment employs instrumented device wrappers that ‘wrap’ an existing disk, RAID, DASD, or other storage device where the transactional change files (logs or journals) reside that are employed by the RDBMS. As deployed, the RDBMS may merely see such a device as a block device or “disk.” Moreover, the operating system may consider such devices as a driver built on the existing raw device, or even as a file residing on some file system.

This approach, however, may include additional changes on the RDBMS to “explain” to the database server that the transactional change files (logs or journals) now reside on the other (instrumented) device, which may be a driver, although the files may actually remain at the same location.

If some OS includes a layered driver architecture, then write interceptors may be built as a filter or as an additional layer along with other existing block device drivers, rather than creating a separate device driver. This simplifies the configuration and deployment of the driver, because such a solution may be much less intrusive and may not require any changes to the RDBMS.

Illustrative Operating Environment

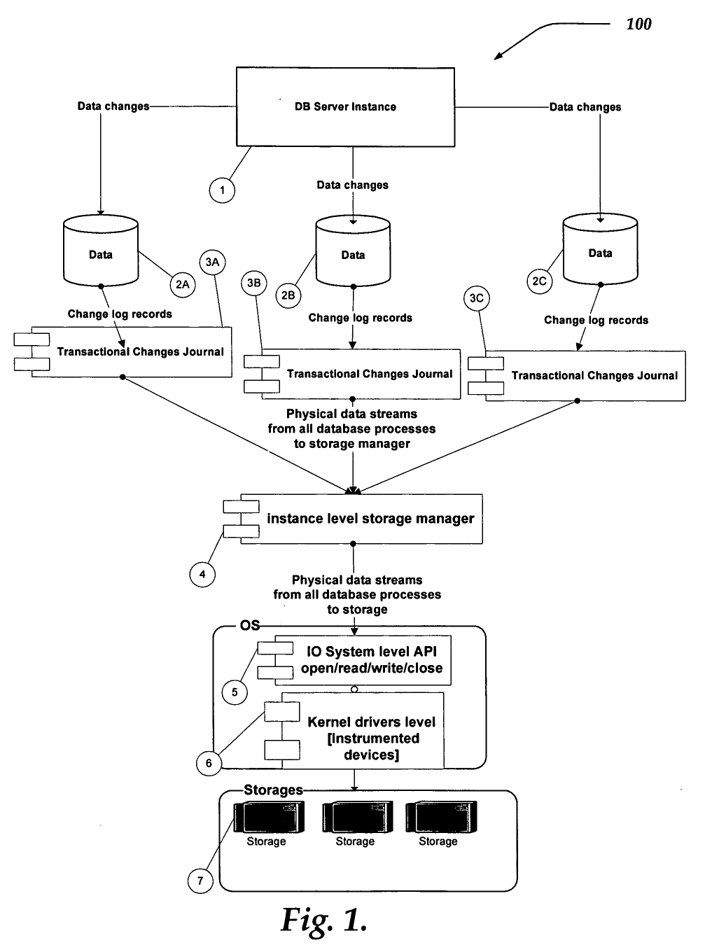

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes DB server instance 1, databases 2A-C, transactional change journals 3A-C, instance level storage manager 4, IO system level API wrapper 5, instrumented device driver 6, and underlying storage 7.

DB server instance 1 includes a combination of processes or threads set with an appropriate shared and private memory. The memory and processes of DB server instance 1 may be employed to manage associated instance data and serve instance users. Accordingly, and based on a specific vendor RDBMS design, each instance 1 may operate one or more databases, such as databases 2.

Databases 2A-C include a set of physical data files with an appropriate set of one or more transactional journals or redo log files. In the special case of shared database clusters, where a single database may be shared by several instances, each instance may have its own set of redo log files (e.g., its own redo thread or stream). In the case of a failure, redo records from substantially all of the appropriate threads may be sorted by a timestamp before being applied to database files during a recovery process.

Typical RDBMS that employ change/transactional journals may be divided into four categories. The first such category, called single instance—single database, is where a single instance operates a single database with a single transactional journal (redo stream). Examples of such current RDBMS implement include Oracle's Enterprise Edition, IBM's DB2 Enterprise Edition, and MySQL's InnoDB. A second category, called single instance—multiple databases, arises where a single instance operates multiple databases, and each database has its own single transactional journal (redo stream). Examples of RDBMS employing this structure include MSSQL's server and Sybase's SQL server. A third category, known as multiple instances—single databases, includes Oracle's RAC/OPS. Similarly, a fourth category, known as multiple instances—multiple databases, includes, for example, IBM's DB2 Enterprise Edition which has several partitions where each partition can theoretically be considered as a database (consistent on the row level) while each transaction coordinator (instance) manages its own redo thread for all applicable databases.

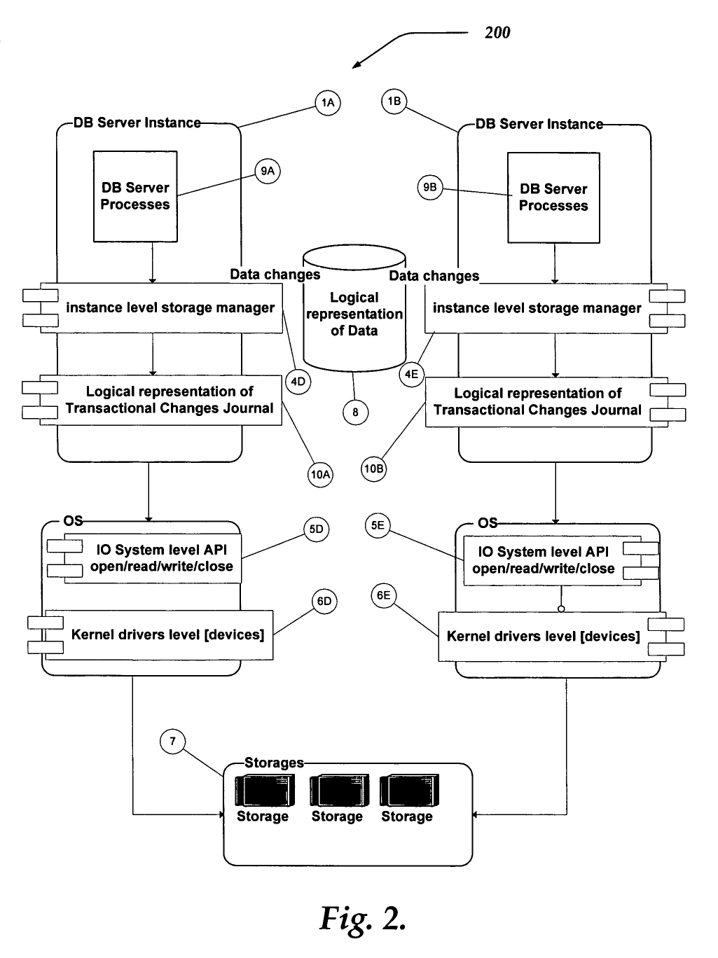

It is sufficient to show how the present invention is applicable to the second and third categories, because the first category may be seen as a sub case of the second and third categories, and the fourth category may be viewed as a hybrid of the second and third categories. As such, FIG. 1 represents the second category, and FIG. 2 represents the third category of database structures.

Transactional change journals 3A-C, sometimes called redo streams include log records that may be employed to track changes and other actions upon databases 2A-C, respectively.

Instance level storage manager 4 represents a first layer of hierarchy level interceptors that may be configured to intercept the transactional change record and data blocks that are written into the transactional change journals 3A-C as log records. Change record blocks may be intercepted, since change records may be a preferred way to catch data for replication, while data blocks may be selectively intercepted to allow support for no logging or direct writes replication. However, the invention is not so limited, and either may be intercepted and employed.

IO system level API wrapper 5 represents a second layer level interceptor as descried above. IO system level API wrapper 5 can be implemented by wrapping, for example, libc functions by dlsym with RTLD_NEXT parameter on a UNIX system. Similarly, IO system level API wrapper 5 can be implemented by wrapping a LoadLibrary and then using GetProcAddress methods on a Windows environment.

Instrumented device driver 6 represents a third layer hierarchy level interceptor that is configured to intercept change record and data blocks before they may be flushed to disk. In one implementation on a UNIX system uses a raw device in order to store logs and data files.

If a specific OS includes a layered driver architecture, then a write interceptor may be built as a filter or as an additional layer of another existing block device driver rather then as a separate device driver. This may simplify the configuration and deployment of the driver, because such a solution may be much less intrusive and may not require any changes to RDBMS.

Where the O/S includes a layered driver architecture doesn't provide an appropriate mechanism for writing a driver to intercept writes performed on file system level, a file system may be created above a block device driver. Writes may then include file system information that may result in additional parsing. In another approach, an existing file system may be modified to include instrumentation.

Underlying storage 7 includes the physical storage, including, but not limited to disks, RAID, EMC, collections of disks, and the like.

FIG. 2 shows a functional block diagram illustrating another embodiment of an environment for practicing the invention showing the three layers for instrumentation. However, not all of these components may be required to practice the invention, and variations in the arrangement and type of the components may be made without departing from the spirit or scope of the invention.

FIG. 2 includes many of the same concepts, and substantially similar components as are shown in FIG. 1. However, in FIG. 2, the replication algorithm may be more complex, because it includes multiple redo streams that may include changes from the same database. This means, changes from the several sources may be sorted by a timestamp before they are applied.

There is nothing special in the master-to-master replication systems and even in the master-slave replication system in case of “multiple masters-single slave,” where changes from all available masters may be sorted by timestamp before being applied.

Thus, as shown in the figure, system 200 includes DB server instances 1A-B, database 8, transactional change journals 10A-B, instance level storage manager 4D-E, IO system level API wrapper 5D-E, instrumented device driver 6D-E, and underlying storage 7.

Components in FIG. 2 operate substantially similar to similarly labeled components in FIG. 1 in some ways, albeit different in other ways. That is, DB server instances 1A-B operates substantially similar to DB server instance 1 of FIG. 1, except that DB server processes 9A-B are illustrated. Moreover, database 8 is substantially similar to databases 2A-C of FIG. 1; transactional change journals 10A-B operate substantially similar to transactional change journals 3A-C of FIG. 1; instance level storage manager 4D-E operate substantially similar to instance level storage manager 4 of FIG. 1, except that here they operate within DB server instances 1A-B, respectively; IO system level API wrapper 5D-E operate substantially similar to IO system level API wrapper 5 of FIG. 1; and instrumented device driver 6D-E operate substantially similar to instrumented device driver 6 of FIG. 1.

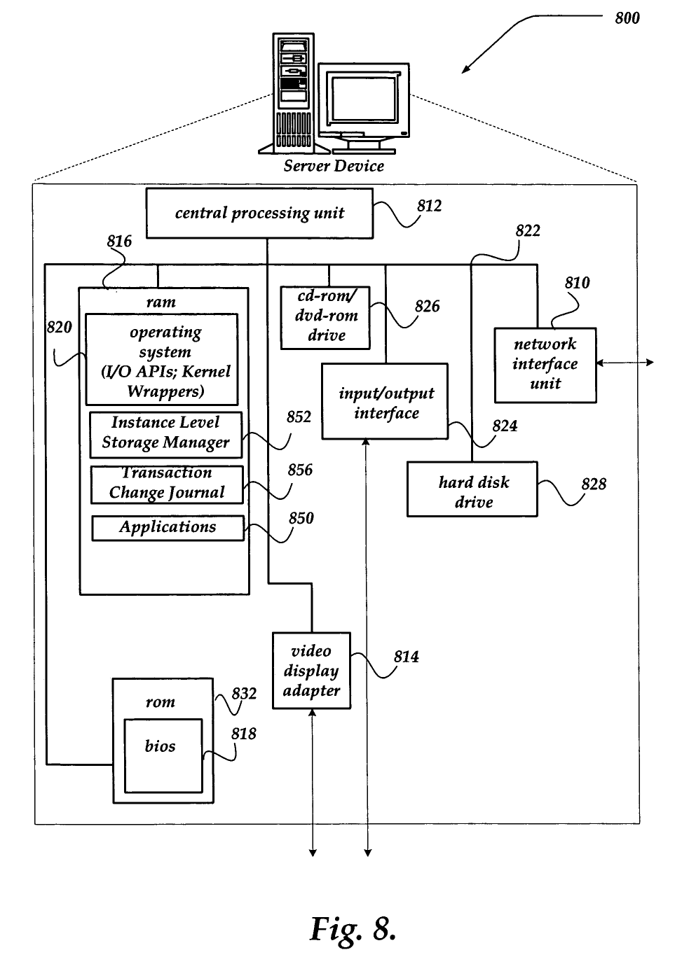

Furthermore, the systems of FIGS. 1 and 2 may operate within a single computing device, such as described below in conjunction with FIG. 8. Alternatively, the systems may operate across multiple computing devices that are similar to system 800 of FIG. 8.

Illustrative Operations

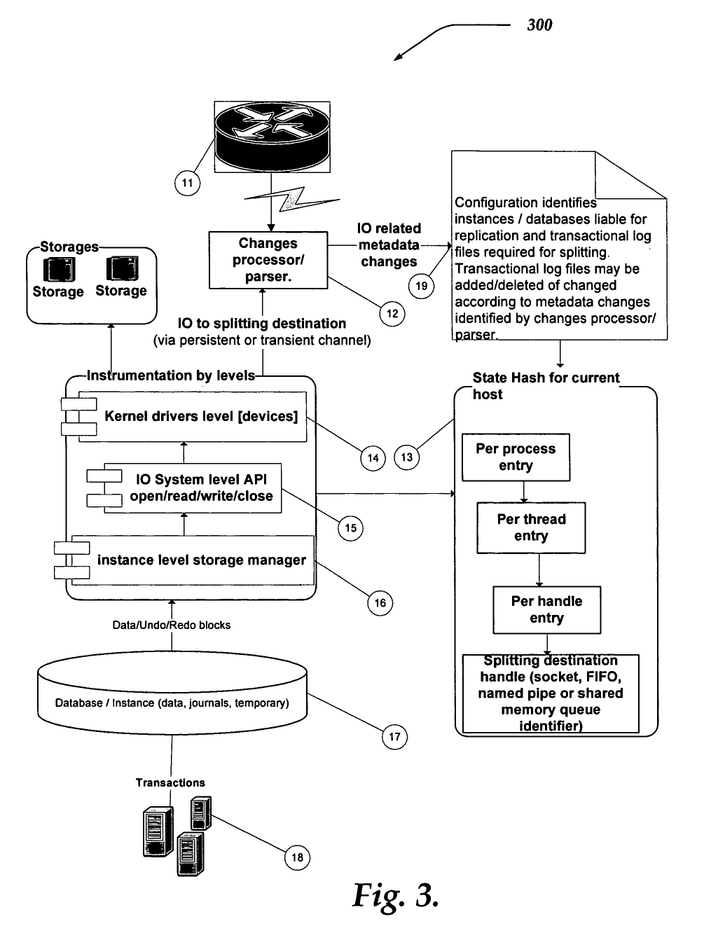

The operation of certain aspects of the present invention will now be described with respect to FIGS. 3-7. FIG. 3 illustrates a logical flow diagram generally showing one embodiment of a process for employing an instrumented layer for a high level change/data interception.

Starting at 18, Transactions generators, users, applications, TP monitors interactions, application system applications, real-time applications, and the like, perform various transactions.

Flow moves next to 17, which represents a Database/Instance (data, journals, temporary, and so forth). Block 17 illustrates the category described above as a Single Instance—Single Database. However, the invention is not limited to this category, and another may be used. Block 17, instance, receives transactions from (18) and performs the regular work of database instance, e.g. answering to query (select) statements, writes on DML statements, metadata changes and writes on DDL statements and sync. A commit or rollback may operate in the same way (e.g. commit just setting bit that transaction committed while rollback performs opposite statement for each statement in transaction in opposite order of execution). Such commit behaviors are called FAST COMMITs.

Writes performed by (17) may then be intercepted then by (16), (15), and/or (14) according to the selected implementation mechanism for that RDBMS. Input/Output (I/O) blocks will be duplicated, if necessary, and one of these blocks is used to perform original I/O operation, such as a write operation, while the duplicated block will be sent to the RepkaDB replication engine (11) via one of a predefined channel, e.g. TCP/IP, Named Pipe, Shared Memory or Persistent Queue, and so forth.

Block 16 represents an Instance level storage manager, as described above. After the RDBMS Instance starts up, it automatically will start the instance level storage manager 16, which may be implemented in separate shared library. However, other implementations may be employed.

In one embodiment, the shared library may be implemented from scratch, such as when the API is open or reproducible. This may be the case, such as in Oracle ODM (Oracle Disk Manager). In another embodiment, however, it may be changed or instrumented (all calls to I/O functions may be replaced by calls to other functions via binary code instrumentation, or the like), since most binary executable formats such as elf, elf64, PE, and the like, are open.

These functions will SPLIT part of the requested writes in addition to the requested I/O operations. SPLIT here means that the data or change block will be duplicated as described in (17). In general, almost all platform specific synchronous and asynchronous I/O functions are intercepted, since most of databases prefer to use asynchronous I/O. In addition, open handle and close handle functions can be intercepted to have mapping between handles and file names to catch change and data blocks. For example on Sun Solaris system the following functions may be instrumented: open, close, write, aiowrite, aiocancel, aiowait.

In yet another embodiment, where an instance level storage manager API is available (for example in Oracle ODM case), no instrumentation may be employed but rather an instance level storage manager implementation may replace the default implementation supplied by the RDBMS vendor.

Block 15, represents the IO System level API (such as open/aiowrite/aiocancel/aiowait/write/close), as described above.

Another embodiment for intercepting these records is the lower level of I/O of Operating System (OS). Instead of modifying instance level storage manager, I/O calls on the lower level can be intercepted. This means, all calls to system I/O functions from specific process or set of processes may be replaced by calls to other functions.

On most UNIX and Windows systems this approach can be implemented using OS shared library mechanism as described in (5). The functions that will be wrapped may have the exact same signature as the functions mentioned in (16).

Block 14, which represents the Kernel level drivers [devices] described above, can be implemented in cases where (16) API may not be available, or when (16) binary code instrumentation is not desired. This may be a desirable approach when, for example, the user doesn't like overriding I/O functions solution, because of its intrusive fashion, RDBMS vendor support issues, or the like. Additionally, overriding I/O functions may have some performance impact on the systems that perform a lot of open/close file operations that may not be related to I/O operations on redo logs and RDBMS data files, or due to additional memcopy operations for appropriate buffers. In the case of kernel level drivers or layered filter drivers less memory buffers may be copied. In such cases, then the OS kernel or user (if supported) level driver may be used.

On a Windows layered drivers model, additional upper-filter driver may be used for the appropriate device, where for example transactional change journals for single specific database will reside. Then the IO block interception and duplication may be simplified. It is possible also to employ a more complex schema with Windows SCSI Miniport Driver model and usage of RAW device as store for transactional change journal. For instance, MS SQL {as a general case} database pubs have transactional journal file pubs01.ldf, which resides in file d:\mssql\data\pubs01ldf. Then an appropriate driver may “mount” this file to device \\.\PseudoDrive\pubs01ldf. Then, database dictionary can be updated to point to the new file location, where \\.\PseudoDrive is actually a pseudo physical disk that holds just a mapping from the real files to the pseudo disk partitions.

An UNIX kernel level block device driver may be used as a raw partition device, because an implementation of UNIX may not offer a layered driver architecture. Additionally, a kernel level may provide better performance than at the user level, but in general, performance is likely not to be better than layered driver implementation.

As used herein, the term ‘per system,’ includes per current OS instance, a physical Unix/windows or other OS operated machine, as well as virtual machine wide. Additionally, a process Id or job id may be considered as unique per system, where a thread Id may be unique per a process (but not per a system). Depending on the RDBMS vendor design, a RDBMS instance can be multi-processed with shared memory; multithreaded with no shared memory; or a hybrid type, such as multi-processed within shared memory, where each process may spawn multiple threads.

Different processes by definition may not share I/O handles and in many systems they do not share the same I/O handles. If a RDBMS instance is multithreaded, threads may either share or not the I/O handles. If I/O handles are shared by different threads, then the access to each I/O handle are typically synchronized in the mutual exclusion fashion. However, typically, most multithreaded RDBMS instances do not share I/O handles, to avoid serialization on high-end SMP machines. So each thread opens its own I/O handles. This means that if threads T1 and T2 belong to the same RDBMS instance, they will open the same file xxx.dbf, and each T1 and T2 threads will have its own handle.

Block 13 represents a state hash (or hash table) for the current host system. As shown in the figure, State Hash is a hash table that may be structured as a multi-level hash table to serve both multi-processed and multithreaded databases. Its implementation is dependent upon the particular RDBMS that participates in replication. However, there is typically a single state hash per system, which can be an OS instance, machine, or a virtual machine. One embodiment of the state hash is as follows:

hash {process id (key) ->

hash {thread id (key) ->

hash {IO handle (key) ->

(support structure (value including file name, statistics
and an optional list (A') of expected writes to catch)

}

}

}

where optional list (A′) is list of expected writes.

The key (index) for the upper {most outer} level of hash is the process id. Its value includes another hash table, structured with a thread id as a key, and with a value that is another hash table for a handle ->support structure. The support structure includes a file name, path and optional list (A′) of expected writes to be caught.

Each time parser (12) identifies that a direct/no-logging write to some data file is to be intercepted, parser (12) posts the range of the expected blocks to the optional list (A′) for each open handle (handle for data file is open once per system). Interceptor (either (14) or (15) or (16)) then intercepts the expected write. This write is sent to parser (12), and Interceptor removes this entry from the optional list (A′).

The state hash is a persistent hash shared between all RepkaDB processes of the current host, which in turn holds a mapping between handles and file names in order to catch the desired change and data blocks. As used herein, persistent hash includes the case where it is persistent across process failures such as shared memory, but may be destroyed in the case of machine failure or restart. All I/O handles are typically destroyed on machine failure or restart.

Each process or thread may be using its system wide unique process id or thread id to identify all of the related I/O handles. I/O handles may be represented by numbers that are unique inside the process address space. The OS kernel maintains a special resource table to map between the process id plus handle and the wide unique resource identifier of the kernel system. However this resource identifier may not be available to a user lever process. That process (or thread) may have handles opened along with the handle operating mode (e.g. read-write, read-only, write-only, etc.). Handles opened in the read-only may not be stored in this hash. During every write operation, when writing a thread identified via (19) for those write operations that may be intercepted, writing thread will duplicate the I/O buffer and send it along with the I/O handle to the parser (12).

No-logging operation requires interception of transaction changes journal file writes and data block writes. This mechanism may be used for filtering of those transaction changes according to a State Hash mapping between handle and file.

If a write of other than transaction changes data (e.g. data for temporary or debug log file used by the RDBMS instance) is detected, then such records may not be intercepted and sent to the parser. Instead, the write operation will be performed in the regular way.

One embodiment of the no-logging operation catch may include the following:
a) Parser (12) catches and identifies a no-logging operation related to a metadata change.
b) Then parser (12) updates the State Hash, causing a direct data writer process to intercept the appropriate data blocks to catch a direct operation via a separate mechanism in parser (12).
c) Separate mechanisms in the parser (12) imply that data blocks will be parsed by using data block parser and not regular redo block parser.

For example, on an Oracle database, it will cause DBWRXX process (UNIX) or thread (Windows) to perform SPLITTING of the blocks related to direct write with “no logging.” Those blocks will be sent to the data block parser, as opposed to the general case where the redo block parser receives blocks from LGWR.

For IBM DB2 similar roles may be performed by db2 pclnr as the data block writer and db2logw as the redo record writer process.

This algorithm is directed at avoiding a slowdown to the IO response time in cases of asynchronous replication. In the case of a synchronous replication, however, the same writing thread may wait until the I/O block is duplicated, filtered, and sent, and the target acknowledgement is received. This may increase the I/O response time, but at same time will increase the reliability and addresses the point-in-time synchronization of all databases involved in the replication.

Block 12 represents the changes processor or simply, parser. The parser operates as an input collector to the RepkaDB engine (11). The following example shows how Block 12 (parser) operates and how it interacts with block (32) to avoid a transaction ping-pong in the master-to-master replication environment. For example: Instance Q is running on Machine A and may be involved in the master-to-master replications, then the parser parses redo blocks intercepted from Instance Q. The Parser represents a master side of replication for instance Q. Post Task represents a slave side of replication for instance Q and is connected to Q. Post Task performs DML/DDL commands (inserts/deletes/updates) into Instance Q (after receiving the commands from other machines from RepkaDB). PostTask may run on the same machine where the parser (Changes processor) is running, since the parser and the Post Task likely include extremely fast inter-process communication facilities. This enables the implementation of the Master-to-Master replication real-time ping-pong avoidance that is described in more detail below. Ping-pong transactions change records are filtered out by their transaction ids, which are generated on behalf of (32), as described below.

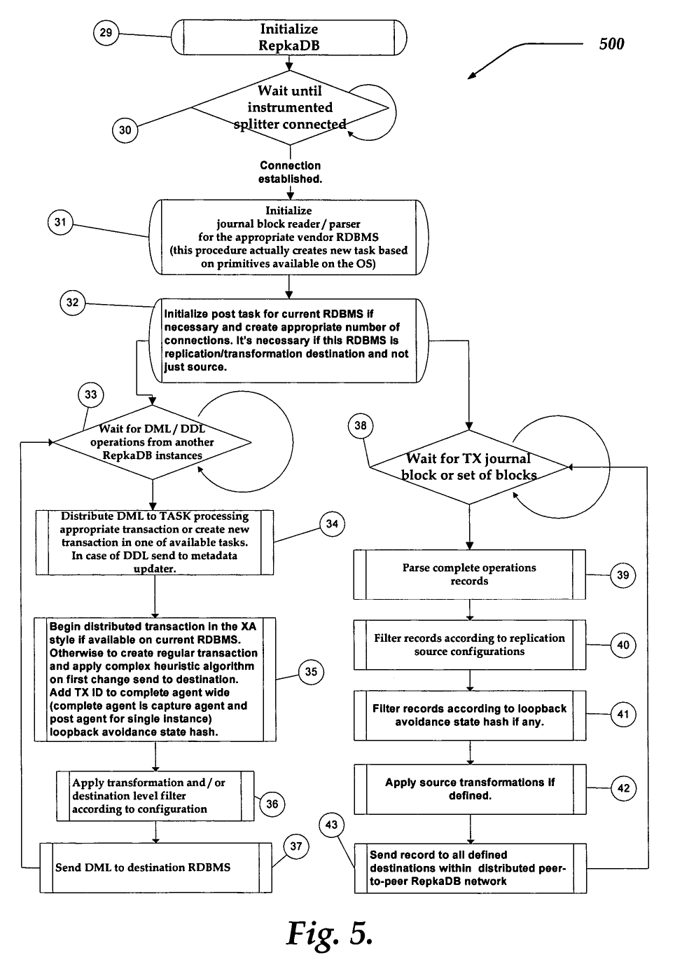

One embodiment of a parsing algorithm is as follows:
a) Receive split change blocks.
b) Parse the change blocks and concatenate redo records.
c) Perform initial pre-parsing of the redo records to identify cases where data block interception may be employed.
d) Perform initial filtering of the records. This may be performed to avoid extensive network load, however, such actions are not required.
e) Perform filtering by the transaction ids in order to support Master-to-Master replication real-time ping pong avoidance implementation (described below) in conjunction with IPC messages from Post Task (32) as described in more detail in conjunction with FIG. 5, below.
f) Perform real-time records compression as required.
g) If data block interception is required, perform call back to splitter mechanism by updating State Hash (13).
h) In the case of (“f”) above, receive and parse requested data blocks.

One of the major goals of each streaming replication solution is to run in Fast Commit mode, e.g. changes from a source beginning to be propagated to the destination database, before they has been committed on the source database. In a general purpose system, most of the transactions are committed and just very few are typically rolled back. The optimal and simplest case is where each intercepted change performed on the object defined for replication will be propagated to all the destinations immediately.

However, this may not work in a master-to-master mode replication configuration. Intercepted changes performed on the object defined for replication, can now be performed by, a real database user/application server/TP monitor or application, and then this change may be replicated to all destinations immediately.

The RepkaDB post task can act on behalf of the RepkaDB capturing agent, which already intercepted the change on another instance. In this case the invention filters this change out and does not replicate it in order to avoid ping-pong.

Intercepted change records can be filtered out by using a Transaction Id, because a Transaction Id can be found as part of the change record in the change log or transaction journal. Then:
a) On every system supporting “BEGIN TRANSACTION” the transaction id is generated after the “BEGIN TRANSACTION.” The generated transaction id can be identified by the RepkaDB post task and be sent to the parser (12) BEFORE a first change record has been generated by the RDBMS for this transaction. Then parser (12) can filter out all the change records that belong to the loopback transactions.
b) On a system supporting a XA distributed transactions mechanism, transaction id are generated after a xa_start_entry call for this transaction. Then the generated transaction id can be identified by the RepkaDB post task and be sent to the parser (12) BEFORE the first change record has been generated by the RDBMS for this transaction.
c) On a system that does not support either “BEGIN TRANSACTION” or XA distributed transactions mechanism, the transaction id may be generated after the first change performed by this transaction.

This means, that parser (12) may not be able to filter out loop back transaction nor send a corrected (non loopback) transaction to the RepkaDB Engine (11). Because a first change record has been generated and caught BEFORE the post task had a chance to identify the transaction id, the parser may not filter out the first change record that belongs to the loopback transaction. This means that in the best-case, fast commit mechanism may not be applied.

However, a heuristic algorithm (35), as described below in conjunction with FIG. 5 may be employed, for the case in parser (12). Briefly, the algorithm includes the following steps:

After a first change belonging to some new transaction is received and parsed by parser (12), parser (12) allocates temporary space and the change record may be copied there. From this point-in-time and until this transaction is identified either as a loopback transaction or as a “to be propagated” transaction, this transaction will be called an “in-doubt transaction.”

Parser (12) may wait a predefined amount of time (so called maximum change id propagation delay) to receive the transaction id from the post task; this transaction may be identified as a loopback.

If transaction id (mentioned in previous step) was received within a predefined amount of time, then remove the stored change record and filter out all subsequent changes belonging to this transaction (using transaction id). This in-doubt transaction has been identified as a loopback transaction.

If a maximum change id propagation delay timer expired (e.g. time is over, but loopback transaction id has not been identified by a call from the post task), this and all subsequent changes belonging to this transaction (by transaction id) may be propagated to the RepkaDB Engine (11). This in-doubt transaction has been identified as right to propagation transaction.

If subsequent change records belonging to an in-doubt transaction are received by the parser before the transaction state has been changed to loopback or “to be propagation,” all these change records may be stored in a temporary space in the context of the parser (12) and wait to determine how this in-doubt transaction will be resolved.

The algorithm described above is heuristic because the propagation delay includes a heuristic value (e.g. may be that post task is very busy and can have a large delay between a first DML operation for a specific transaction and a transaction id identification, or between a transaction id identification and the posting of this transaction id to parser (12)). If this delay is greater than the maximum change id propagation delay, this may cause transaction loopback. In this case this algorithm may result in an increasing propagation delay (configurable value) that makes it virtually impossible having FastCommit. In addition this algorithm may not support a traditional fast commit mechanism. Changes may not be sent to the destination immediately but might wait until the in-doubt transaction is identified as either loopback transaction or “to be propagated” transaction.

Thus, as a solution to this issue, and others, the present invention proposes a new mechanism, called herein as a Master-to-Master replication real-time ping pong avoidance implementation.

As an example, consider the Master-to-master replication running between Table T1 in database Instance A and Table T2 in database Instance B. Then, an insert operation is performed at Table T1 in Instance A and is then committed. A redo block that includes these records will be intercepted, parsed, and propagated to be performed at Table T2 in Instance B. An interceptor at Instance B will catch the records for this change (as applied by RepkaDB post record task) and sends it again to be parsed. The Parser that parses records then filters it out to avoid loop back.

However, the transaction id is obtained before a first change record is flushed to Instance B transaction change stream. This is done because the transaction id generated for this transaction on Instance B is after the DML statement is performed. Since DML statements may be performed on the destination instance before the transaction commits, the invention avoids waiting for commit to drop loopback transaction.

The FAST-COMMIT mechanism allows support of very large transactions propagation. Moreover, the FAST-COMMIT provides a shorter transaction propagation for small and middle transactions and is less collision prone. Since many major databases support the FAST-COMMIT, the invention employs it in asynchronous replication in order to reduce latency between the source and destination databases.

In the present invention, when a commit occurs on the source database, all or almost all changes made by this transaction have been sent already and applied to the destination database, the commit is essentially the substantially remaining statement left to be sent to the destination.

Moreover, the present invention may employ an XA (TP monitor) style distributed transactions. Because databases such as DB2 and Oracle support XA style distributed transactions, a transaction may begin via a xa_start_entry, and then the transaction id is generated and may be identified before a first change DML operation has been performed. Databases, such as Sybase, MSSQL, Informix, MySQL and many other databases support “BEGIN TRANSACTION.” Thus the XA is not required and the invention may obtain the transaction id prior to the first DML operation.

Since the transaction id is a part of change record in the transactional journal, the present invention is quite simple and straightforward, as opposed to those solutions where a complex control schema may be required.

Now, back in FIG. 3, Block 11 represents one embodiment of RepkaDB engine. Briefly, RepkaDB operates as a log based heterogeneous replication peer-to-peer enterprise application with master-to-master replication support, conflict resolution and loopback avoidance to encapsulate the invention. One embodiment of a RepkaDB process flow is described in more detail in conjunction with FIG. 5.

Block 19 represents a Configuration service component that is employed to identify instances/databases liable for replication and transactional log files required for splitting.

The configuration service component includes updatable-on-demand configuration services that provide names of the instances liable for replication, transactional journal file or device paths, IPC (inter-process communication) paths, and methods between different paths of the system, and the like. Updatable-on-demand includes, for example, where transactional log files may be added/deleted or changed according to metadata changes identified by changes processor/parser. In one embodiment, changes processor (12) performs the configuration change callback to (19) in order to reflect those changes in the configuration.

If metadata, such as table definition, has been changed and this change has been identified by the changes processor (12), then (12) may send an immediate callback to (19) to allow the next records to be parsed according to the changed metadata. Changes to the configuration may be performed on an immediate or deferred fashion.

In one embodiment, metadata changes provided via callback may be applied immediately while administrative changes such as tables to replicate and destinations may be applied in the deferred fashion, e.g. from 10:00:00.000 AM on Dec. 12, 2005. Moreover, in another embodiment, configuration changes may be applied to all nodes involved to replication using two-phase commit algorithm in all-or-nothing fashion.

In still another embodiment, the replication engine may sleep from the beginning of reconfiguration, until the end.

In another embodiment, where there is an asynchronous configuration with a high load on the system, Persistent Queues may be used for intercepted blocks to avoid data lost.

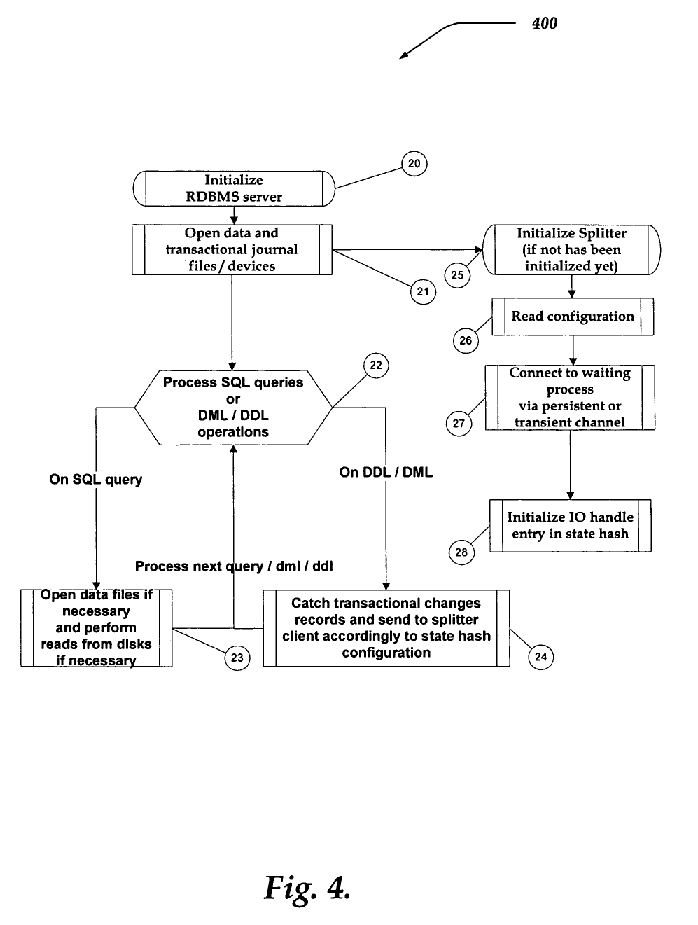

FIG. 4 illustrates a Specification and Description Language (SDL) diagram generally showing one embodiment of a process for a TX change interceptor. The following illustrates substantially similar concepts as FIG. 3; however this figure disregards how change and data blocks may be intercepted.

As shown in the figure, block 20 represents the RDBMS instance startup, which will trigger initialization of interception process. Moving to block 21, data and transactional journal files and devices are opened. That is, after the RDBMS instance has been started, it opens its own data files and transactional journal according to a vendor algorithm in order to begin normal operation.

Process 400 continues to block 25, where, if it is not already active, the splitter is initialized. A first call to a storage manager instrumented function, OS I/O function wrapper or kernel driver becomes a trigger to SPLITTER process initialization. In turn, the Splitter then initializes the State Hash (13), if it's not yet initialized. Processing continues, next to block 26, where a configuration is read. That is, after the splitter was initialized, it attaches itself to configuration service (19) to identify the State Hash address and the appropriate changes processor addresses (12). Either of these may be involved in the replication process at this time.

At block 27, a connection is made to a waiting RepkaDB process via any persistent or transient channel. According to the values received from configuration service (19) connections are established to other components of the system. Connections may be created, for example, using a TCP/IP socket, shared memory or the like.

At block 28, the IO handle entry in the state hash is initialized. Initialization of the new IO handle entry in the State Hash (13) may include adding handles to file a mapping for each open file, or the like.

At block 22, the SQL queries, DML/DDL operations, and the like are processed. The main loop of every generic SQL based RDBMS is to wait for connections, then per connection wait for queries/DML and then perform the SQL statement and wait for the next statement.

At block 23, where appropriate, data files are opened, and reads from disks are performed. Results of the reads are returned to a client.

At block 24, transactional change records are caught and sent to the splitter based, in part, on the configuration of the state hash. If a DML statement is performed and change data is flushed to disk then the instrumented layer, OS I/O wrapped or kernel driver catches the change blocks, and as appropriate data blocks, and sends them to the appropriate parsers, according to configuration service (19) data. Process 400 may then continue to execute throughout the execution of the RDBMS server.

FIG. 5 illustrates a SDL diagram generally showing one embodiment of a process for the RepkaDB engine. Process 500 is employed in conjunction with process 400 of FIG. 4 to provide a complete picture of how the RepkaDB performs a master-to-master replication in a complex heterogeneous environment.

At block 29, the RepkaDB replication engine initialization occurs, which includes reading a configuration from configuration service (19), opening sockets or other IPC ports, connections, and the like. At block 30, a wait arises until instrumented splitter is connected.

At block 31, the journal block reader, and parser for the appropriate vendor RDBMS is initialized. This includes creating any new tasks, based on primitives available on the OS.

Since RepkaDB uses a multi threaded model where it is possible and a multi process model otherwise, RepkaDB network reactor continues to wait for a connection from other instances. Then RepkaDB may effectively handle connections from several RDBMS servers, even those that may belong to different vendors.

If the instance is both a replication source and a destination, it may initialize a shared set (for a transaction id to be filled by Post Task (32) by active Post transactions) in order to establish a Master-to-Master replication real-time ping pong avoidance mechanism as described above. The address of this data set may be transferred to an appropriate Post Task (32) via configuration service (19), or directly related on RepkaDB processing/threading model.

In addition, in case of multiple sources—single destination model, records are sorted according to a timestamp. As a note, it is anticipated that the system clocks of the servers involved in the replication will be reasonably synchronized using NTP or similar approach. This is performed to minimize any collisions that may arise. As an aside, in the Single Database—Multiple Instances, the clock synchronization is not relevant since all records produced by all redo threads are sorted using a unified timestamp sequence.

At block 32, the post task is initialized for the current RDBMS, and any appropriate number of connections may be created. This block arises where a particular RDBMS is a replication/transformation destination and not just a source. For that purpose a connection to the transaction id shared set is established by (31).

At block 33, a wait for DML/DDL operations from another RepkaDB instance occurs. The wait is for records to be parsed, sorted, and sent from another RepkaDB instance via (31)

At block 34, DML operations are distributed to a task processing the appropriate transaction. In one embodiment, a new transaction may also be created for one of the available tasks. In a complex replication model a lot of concurrent transactions could be performed at each point-in-time and a connection creation on demand may be expensive from the CPU point of view. Therefore, it may be preferred to use a predefined connection and task pool. However, the invention is not so limited. Depending on the available OS primitive's task, it can be a process, thread, or set of the threads. Each task may run several transactions.

Then according to the transaction id, the next received DML statement that belongs to an active transaction may be modified, e.g. multiple transactions may be performed on the same connection to a database, and active transactions may be switched according to each received DML statement.

If the received DML operation is performed on the dictionary tables and is recognized as a DDL statement, then this statement will be sent to the metadata updater. The metadata updater includes a configurable heuristic mechanism that decides to update a destination schema metadata when a source is updated, and also determines how to perform such updates. In one embodiment, a database administrator may decide using one of several available policies, including, but not limited to: a) Propagating all metadata changes from source to destination; b) Distributing metadata change to destination and all equivalent sources; c) Distributing the change to column types or names to the columns involved to replication and not to distribute added columns or data for these columns; and d) not propagating any metadata changes and just write message to error log.

At block 35, where it is available, begin distributed transactions in the XA style. If XA is not available, then begin explicit transaction using “BEGIN TRANSACTION statement if supported on current RDBMS, or a similar operation. Otherwise, create a regular implicit transaction and apply a complex heuristic algorithm on the first change sent to the destination to avoid loopback transaction. One implementation may consider implementing a “delayed” change propagation. For example, identify a beginning of the transaction, then wait some time. If this transaction is started by the Post Task, then filter it out, otherwise, send it to the destination.

Add TX ID to the shared set for transaction id as established by (31). This may be performed to generate and get a transaction id transaction ID before a first change is applied to the destination RDBMS. This may also allow effective filtering of parsed records and thus to implement loopback avoidance without significant overhead.

If transaction for that source and transaction id has already been established, just switch an active transaction for this connection, as described in (34).

At block 36, apply the transformation and/or destination level filter according to the configuration. Several basic transformations may be configured to be performed on undo and redo change records. This may be done on either the source side, or one or more destinations, or both source and destinations. If it is done on the source, then it will be done for all destinations at once. Same or different transformation may be done on each destination. In addition, undo and/or redo change vectors may be transformed on the source and then on one or more destinations. Such transformations may include arithmetic operations on one or more numeric columns, type conversions or string based transformation on character columns, and the like. This process may happen in near real-time (streaming) replication environment. Destination filtering allows filtering records based on one or more undo or redo columns values as defined using SQL style statements, or the like.

At block 37, DML is sent to the destination RDBMS. The transaction begins to be applied before it is committed or rolled back on a source database. This allows replicating very long transactions without being limited by memory or persistent queue storage constraints.

In addition, conflicts/collisions detection is performed at block 37. There are at least three kinds of conflicts that may arise in a multi-master replication environment. They include:
Conflict of UPDATE DML operation. Such conflict is possible, for example, when at the same period of time two transactions are started on different instances and try to update the same row. One of the instances usually is a local instance.

Conflict of DELETE DML operation. Such conflict may happen when, for example, two transactions originating from different instances perform a delete on a row in one transaction while another transaction updates or deletes the same row. After the first delete, such row is not available anymore to be updated or deleted by another transaction.

UNIQUE constraint conflict. Such conflict may happen, for example, when a UNIQUE constraint is violated by replication. For instance, if two transactions originated from different instances inserting each one a row with same primary key or updated each one different row with same value that violates a unique constraint.

Update Conflicts may be resolved manually but may also be resolved automatically using one of the pre-defined policies. Depending on the configuration, before applying the change DML, an undo vector (pre-image) may be compared to the data that exists in the rows on which an update statement will be performed. Collision is a case where the updated row has been identified by a pre-image as not equivalent to the data in this row.

The present invention includes several collision detection/resolution policies, including, but not limited to: discarding a conflict update; earliest timestamp where the update with the earliest timestamp is performed; latest timestamp, where the update with the latest timestamp will be performed; and source priority, where each instance may have a priority and the update received from the instance with the higher priority or performed on local instance is performed.

At block 38, a wait occurs for the TX journal block or set of blocks. The wait is for blocks that may be received from (24) but is running on a local instance, as opposed to records processing on (33) received from (24) but running on one or more remote instances.

At block 39, operation records are parsed. This step is similar to (31), but occurs on the source side. The invention employs a simplified source side parser such as (12) and a complex destination side parser such as (31).

At block 40, records are filtered according to the replication source configurations. That is, if source instance record filters are implemented, then the filters are applied at this block.

At block 41, records are filtered according to loopback avoidance state hash. Filtering of the records enables avoidance of any Master-to-Master replication real-time ping pong.

At block 42, any defined source transformations are applied. Such source level transformations may be substantially similar to (36) but may be applied once for all defined destinations, while (36) are typically defined on a per destination basis.

At block 43, records are sent to all defined destinations within the distributed RepkaDB system that may be defined for the current source via configuration service (19). Process 500 may then continue to operate until the RDBMS is terminated, or the like.

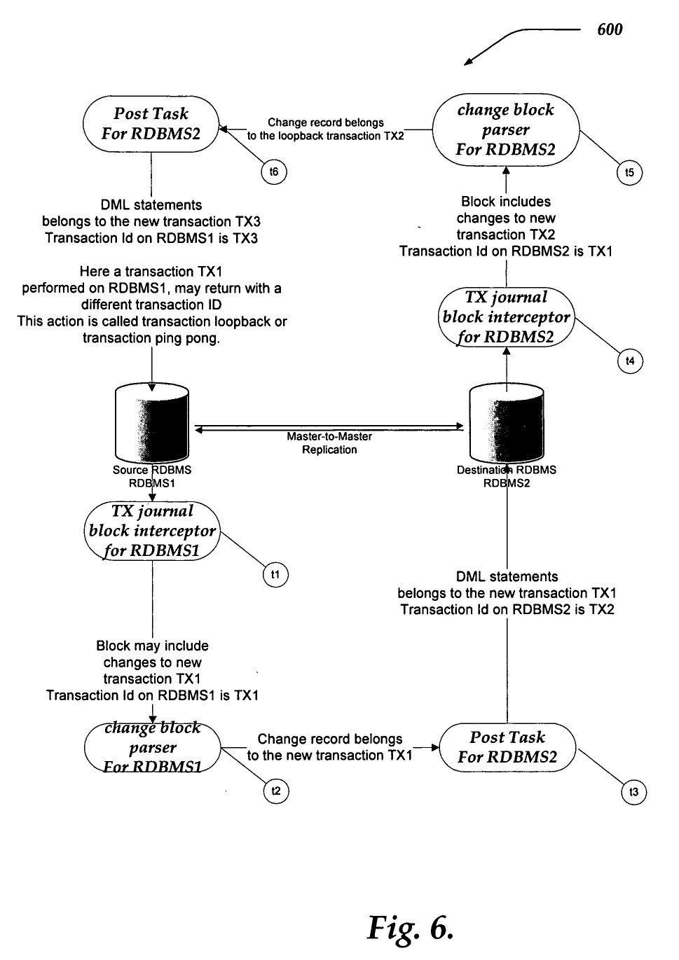

FIG. 6 illustrates a logical flow diagram generally showing one embodiment of a process for transaction loopback. As shown in the figure, the heuristic algorithm shown herein is that which may be employed in conjunction with block 35 of FIG. 5 above, and is described in more detail in conjunction with block 12 of FIG. 3. As used in the figure, t1-t9 implies differing points in time, with t1 being earlier in time to t9.

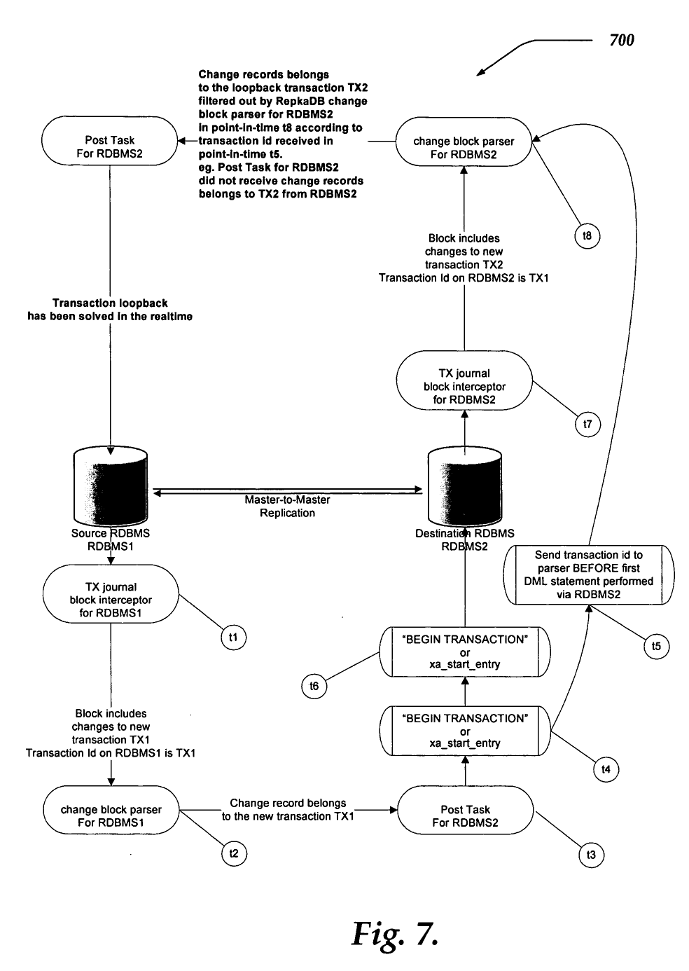

FIG. 7 illustrates a specification and description language (SDL) diagram generally showing one embodiment of a process for transaction loopback filtering. Illustrated is an approach to resolving loopback by filtering, based on transaction IDs, as described above at block 12 of FIG. 3. As in FIG. 6, t1-t9 implies differing points in time, with t1 being earlier in time to t9.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the operations indicated in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustrations support combinations of means for performing the indicated actions, combinations of steps for performing the indicated actions and program instruction means for performing the indicated actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

FIG. 8 shows one embodiment of a server device that may be included in a system implementing the invention, in accordance with the present invention. Server device 800 may include many more components than those shown. The components shown, however, are sufficient to disclose an illustrative embodiment for practicing the invention.

Server device 800 includes processing unit 812, video display adapter 814, and a mass memory, all in communication with each other via bus 822. The mass memory generally includes RAM 816, ROM 832, and one or more permanent mass storage devices, such as hard disk drive 828, tape drive, optical drive, and/or floppy disk drive. The mass memory stores operating system 820 for controlling the operation of server device 800. Any general-purpose operating system may be employed. In one embodiment, operating system 820 may be instrumented to include IO system level API, kernel device level drivers, and the like, as is described above in conjunction with FIG. 1. Basic input/output system (“BIOS”) 818 is also provided for controlling the low-level operation of server device 800. As illustrated in FIG. 8, server device 800 also can communicate with the Internet, or some other communications network, via network interface unit 810, which is constructed for use with various communication protocols including the TCP/IP, UDP/IP protocol, and the like. Network interface unit 810 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 850 are loaded into mass memory and run on operating system 820. Examples of application programs may include transcoders, schedulers, calendars, database programs, word processing programs, HTTP programs, SMTP applications, mail services, security programs, spam detection programs, and so forth. Mass storage may further include applications such as instance level storage manager 852, transaction change journal 856, and the like. Instance level storage manager 852 is substantially similar to instance level storage manager 4 of FIG. 1, while transaction change journal 856 is substantially similar to transaction change journals 3A-C of FIG. 1.

Server device 800 may also include an SMTP, POP3, and IMAP handler applications, and the like, for transmitting and receiving electronic messages; an HTTP handler application for receiving and handing HTTP requests; and an HTTPS handler application for handling secure connections.

Server device 800 may also include input/output interface 824 for communicating with external devices, such as a mouse, keyboard, scanner, or other input devices not shown in FIG. 8. Likewise, server device 800 may further include additional mass storage facilities such as CD-ROM/DVD-ROM drive 826 and hard disk drive 828. Hard disk drive 828 may be utilized to store, among other things, application programs, databases, and the like.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for database replication, comprising:
intercepting a write operation before a log buffer flush to a transactional change log by employing an I/O instrumentation component;
selecting a portion of information from the intercepted write operation; and
forwarding the selected portion of information to a destination database system for use in replicating the source database system.

2. The method of claim 1, wherein the I/O instrumentation component includes at least one of an instance level storage manager, an operating system function, or a kernel level device driver.

3. The method of claim 1, where further comprising:
updating the destination database system with the selected portion of information after receiving at least one of a commit or rollback statement from the source database system.

4. The method of claim 1, wherein forwarding the selected portion of information further comprises sending the portion of information synchronously for use with real-time replication or asynchronously for other than real-time replication.

5. The method of claim 1, further comprising:
receiving the portion of information at the destination database system;
determining at least one log record within the portion of information;
performing a loopback filtering of at least one log record to determine, at least in part, a redo vector; and
posting the redo vector to the destination database system for use in replicating the source database.

6. The method of claim 5, wherein performing loopback filtering further comprises:
if the source database system supports XA style transactions:
generating a transaction identifier (id) before execution of a first Data Manipulation Language (DML) operation associated with at least one log record, and
employing the transaction identifier to extract selected statements from the redo vector.

7. The method of claim 5, wherein performing loopback filtering further comprises:
if the source database system not does support XA style transactions:
opening a transaction control statement to generate a transaction identifier, and
employing the transaction identifier to parse the redo vector to remove operations that are not to be performed.

8. The method of claim 5, wherein the redo vector is posted to a destination database system within the destination database system as at least one of a Data Manipulation Language (DML) operation or a Data Definition Language (DDL) operation.

9. The method of claim 1, wherein selecting a portion of information further comprises filtering of the records based on a loopback avoidance state hash.

10. A server for database replication, comprising:
a transceiver to send and receive information; and
a processor programmed to perform actions including:
performing a transaction on a source database, wherein the source database is to be replicated;
sending to an in memory transactional change log an instance associated with the performed transaction;
intercepting the instance using an Input/Output (I/O) interceptor that includes at least one of an instance level storage manager, an operating system function, or a kernel level device driver;
generating a vector from the instance; and
sending the vector to an agent, wherein the agent employs the vector to modify a destination database.

11. The server of claim 10, wherein employing the vector further comprises:
transforming the vector to an operation; and
posting the operation to the destination database, wherein the operation includes at least one of a Data Manipulation Language (DML) operation or a Data Definition Language (DDL) operation.

12. The server of claim 10, wherein sending the vector to the agent further comprises:
sending the vector over a channel that comprises at least one of a TCP/IP channel, a named pipe, shared memory, or through a persistent queue.

13. The server of claim 10, wherein generating the vector from the instance, further comprises duplicating a memory block by mapping information associated with the instance to a state hash table.

14. The server of claim 10, wherein employing the vector to modify the destination database further comprises employing a collision avoidance and resolution policy that includes at least one of discarding a conflict update, performing an update based on an earliest timestamp, performing the update based on a latest timestamp, or performing an update based on a priority associated with the update of the destination database.

15. The server of claim 10, further comprising:
if the source database and the destination database are master databases, implementing a master-to-master replication mechanism using real-time ping pong avoidance.

16. A system for database replication, comprising:
(a) a source database system that comprises:
(i) a transaction change log that is in communication with a source database and is configured to receive changes to the source database;
(ii) an Input/Output (I/O) interceptor that is configured to perform actions, including:
intercepting a write operation to the transaction change log;
splitting the write operation to generate a copy of the write operation; and
sending the copy of the write operation within a log buffer to a parsing engine; and
(iii) the parsing engine configured to communicate with the I/O interceptor and to perform actions, including:
parsing the log buffer into at least one log record;
performing loopback post filtering on the at least one log record;
generating a redo vector from at least one log record; and
sending the redo vector to a destination database system; and
(b) the destination database system that is in communication with the source database system and comprises:
(i) a replication post agent that is configured to perform actions, including:
receiving the redo vector;
generating a record based on the redo vector; and
posting the record to a destination database; and
(ii) the destination database that is configured to perform actions, including:
receiving the record; and
employing the record to replicate the source database.

17. The system of claim 16, wherein generating a record based on the redo vector further comprises generating the record to include at least one of a Data Manipulation Language (DML) operation or a Data Definition Language (DDL) operation.

18. The system of claim 16, wherein the I/O interceptor is configured to perform actions further comprising:
if a no-logging transaction to the database is detected:
intercepting the no-logging transaction,
duplicating a data block associated with the no-logging transaction for use in replicating the no-logging transaction on the destination database, and
providing the duplicated data block within the log buffer to the parsing engine.

19. The system of claim 16, wherein performing loopback post filtering further comprises:
if the source database system supports XA style transactions:
receiving a transaction identifier before execution of a first Data Manipulation Language (DML) operation associated with the at least one log record, and
employing the transaction identifier to filter the redo vector prior to sending the redo vector.

20. The system of claim 16, wherein performing loopback post filtering further comprises:
if the source database system does not support XA style transactions:
receiving a transaction identifier based on a “begin transaction” statement, and
employing the transaction identifier to filter the redo vector prior to sending the redo vector.

21. An apparatus for replicating a database, comprising:
a transaction change log for receiving and storing changes to a source database;
an Input/Output (I/O) interceptor that is configured to intercept a write operation at the transaction change log, wherein the I/O interceptor comprises at least one of an instance level storage manager, an operating system function, or a kernel level device driver;
means for generating a copy of the intercepted write operation;
means for generating a redo vector based on the intercepted write operation; and
means for posting a record to a destination database based on the redo vector, wherein the record is in a form of at least one of a Data Manipulation Language (DML) operation or a Data Definition Language (DDL) operation.
